(19) United States
(12) Patent Application Publication
(10) Pub. No.: US 2020/0378917 A1
(43) Pub. Date: Dec. 3, 2020

(54) ELECTROCHEMISTRY SENSOR HOUSING

(71) Applicant: Hach Company, Loveland, CO (US)

(72) Inventor: Cory Scott Miller, Loveland, CO (US)

(21) Appl. No.: 16/424,975

(22) Filed: May 29, 2019

(51) Int. Cl. G01N 27/28; G01N 27/30

(52) U.S. Cl. CPC G01N 27/286; G01N 27/308

(57) ABSTRACT

An embodiment provides an electrochemistry sensor, comprising; a sensor housing; an electrode, wherein the electrode is located within the sensor housing and is located within an orifice at the end of the sensor housing, thereby being exposed to outside the sensor housing and held within the sensor housing; and a rod coupled to an electrical connector, the rod being at least partially housed within the sensor housing, wherein the electrical connector contacts the electrode. Other aspects are described and claimed.

### FIELD

This application relates generally to the housing of an electrochemistry sensor, and, more particularly, to successfully utilizing an electrochemistry sensor in a system.

### BACKGROUND

Properly containing a sensor within a housing is critical for accurately producing information collected by a sensor in a system. Sensors may be used in a system in a variety of ways. For example, information may be received by a sensor that may determine whether to initiate a task or alert when a task is completed. A sensor may receive information regarding whether an issue has occurred in a system or a sensor may receive information to determine that a system is running smoothly. Improperly housing sensors may lead to poor translations of information, ultimately producing an inaccurate end result for a system. An improper sensor housing may result in the failure of a sensor. Therefore, properly housing a sensor is vital to accurately providing information from a system that utilizes at least one sensor.

### BRIEF SUMMARY

In summary, one embodiment provides An electrochemistry sensor, comprising; a sensor housing; an electrode, wherein the electrode is located within the sensor housing and is located within an orifice at the end of the sensor housing, thereby being exposed to outside the sensor housing and held within the sensor housing; and a rod coupled to an electrical connector, the rod being at least partially housed within the sensor housing, wherein the electrical connector contacts the electrode.

Another embodiment provides a system for measuring chemical characteristics, comprising; a measurement chamber; a sensor housing located in the measurement chamber; an electrode, wherein the electrode is located within the sensor housing and is located within an orifice at the end of the sensor housing, thereby being exposed to outside the sensor housing and held within the sensor housing; and a rod coupled to an electrical connector, the rod being at least partially housed within the sensor housing, wherein the electrical connector contacts the electrode.

A further embodiment provides an electrochemistry sensor, comprising; a sensor housing, wherein the sensor housing comprises a low conduction material negating stray conduction from the electrode; an electrode, wherein the electrode is located within the sensor housing and is located within an orifice at the end of the sensor housing, thereby being exposed to outside the sensor housing and held within the sensor housing, wherein the electrode is press fitted into the sensor housing, thereby holding the electrode within the sensor housing; and a rod coupled to an electrical connector, the rod being at least partially housed within the sensor housing, wherein the electrical connector contacts the electrode, wherein the rod comprises a threaded rod that is threaded into the threads of the sensor housing, wherein the rod comprises a conductive material, wherein the electrical connector comprises a pogo-pin.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of computer circuitry

FIG. 2 illustrates an example internal cutaway view of an electrochemistry housing sensor.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well-known structures, materials, or operations are not shown or described in detail. The following description is intended only by way of example, and simply illustrates certain example embodiments.

Conventional methods of creating a housing for sensors used in a system include soldering a crystalline sensor to a circuit board and then overmolding the body of the sensor around the assembly, or using extruded glass sealing, which is when a sensor is placed in a glass tube and then the glass tube was heated and stretched simultaneously around the sensor. Both versions of conventional methods for building a sensor housing regularly encountered leakage when placed in an aqueous solution. Soldering a crystalline sensor to a circuit board and overmolding the sensor, and extruded glass sealing are both time consuming processes, while neither being reliable.

Soldering a crystalline sensor to a circuit board and then overmolding the sensor on the circuit board is a complicated task that regularly encounters issues. Performing the overmolding directly on the circuit board after the crystalline sensor has been soldered does not provide an airtight seal around the sensor. Differences in the coefficient of thermal expansion between the various elements of the sensor prevented the plastic overmold used in a system from sealing against the crystalline sensor. These differences results in bubbles and weak areas within the overmold, which then leads to gaps. These gaps allow for substances to penetrate a housing which can alter information gathered by a sensor or completely negate the sensor or break it.

Extruded glass sealing has been used as a technique for housing sensors for some time. This manual process takes a glass tube containing a sensor and stretches the glass tube as it is being simultaneously heated until the glass is drawn tightly against the crystalline sensor creating a seal. The glass tube is then carefully cut to expose the active portion of the crystalline sensor. This process has been used over time because it may successfully produce housing for a sensor; however, the reliability of this process to produce a useable housing is very low. What is needed is a reliable way to house a sensor in a repeatable manner that improves the longevity and serviceability of the sensor.

Accordingly, an embodiment provides a system and a method for housing a crystalline sensor utilizing press fit methodology. The press fit methodology may provide an improvement over the heat and drawn glass method. In an embodiment, a crystalline sensor, or any type of electrochemistry sensor, may comprise a cylindrical molded housing comprising openings at each side. One of the two openings may be an orifice of a cone-like shape that may comprise an electrode. The other of the two openings of the cylindrical molded housing may be wider than the orifice containing the electrode. This opening may comprise a threaded rod operatively coupled to an electrical connector, where the end of the rod comprising the electrical connector is within the molded housing. In an embodiment, the outside diameter of the threaded rod fits complementary to at least a portion of the inside diameter of the threaded tube. In an embodiment, the electrical connector contacts the electrode. In an embodiment the electrode may be press fit into the orifice of the molded housing, which may result in a proper seal separating the active portion of the crystalline sensor from the rest of the sensor housing. Separation between the outside of the electrode and the electrical connections must be present in all embodiments to assure a system produces accurate information.

The illustrated example embodiments will be best understood by reference to the figures. The following description is intended only by way of example, and simply illustrates certain example embodiments.

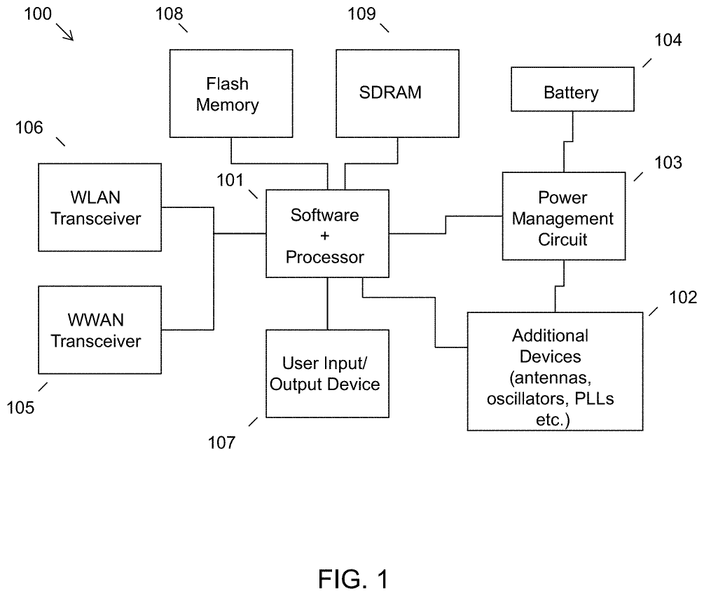

While various other circuits, circuitry or components may be utilized in information handling devices, with regard to a sensor housing according to any one of the various embodiments described herein, an example is illustrated in FIG. 1. Device circuitry 100 may include a measurement system on a chip design found, for example, a particular computing platform (e.g., mobile computing, desktop computing, etc.) Software and processor(s) are combined in a single chip 101. Processors comprise internal arithmetic units, registers, cache memory, busses, I/O ports, etc., as is well known in the art. Internal busses and the like depend on different vendors, but essentially all the peripheral devices (102) may attach to a single chip 101. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 103, e.g., a battery management unit, BMU, which manage power as supplied, for example, via a rechargeable battery 104, which may be recharged by a connection to a power source (not shown). In at least one design, a single chip, such as 101, is used to supply BIOS like functionality and DRAM memory.

System 100 typically includes one or more of a WWAN transceiver 105 and a WLAN transceiver 106 for connecting to various networks, such as telecommunications networks and wireless Internet devices, e.g., access points. Additionally, devices 102 are commonly included, e.g., a transmit and receive antenna, oscillators, PLLs, etc. System 100 includes input/output devices 107 for data input and display/rendering (e.g., a computing location located away from the single beam system that is easily accessible by a user). System 100 also typically includes various memory devices, for example flash memory 108 and SDRAM 109.

It can be appreciated from the foregoing that electronic components of one or more systems or devices may include, but are not limited to, at least one processing unit, a memory, and a communication bus or communication means that couples various components including the memory to the processing unit(s). A system or device may include or have access to a variety of device readable media. System memory may include device readable storage media in the form of volatile and/or nonvolatile memory such as read only memory (ROM) and/or random access memory (RAM). By way of example, and not limitation, system memory may also include an operating system, application programs, other program modules, and program data. The disclosed system may be used in an embodiment to house a variety electrodes, and thus, creating electrochemistry sensors.

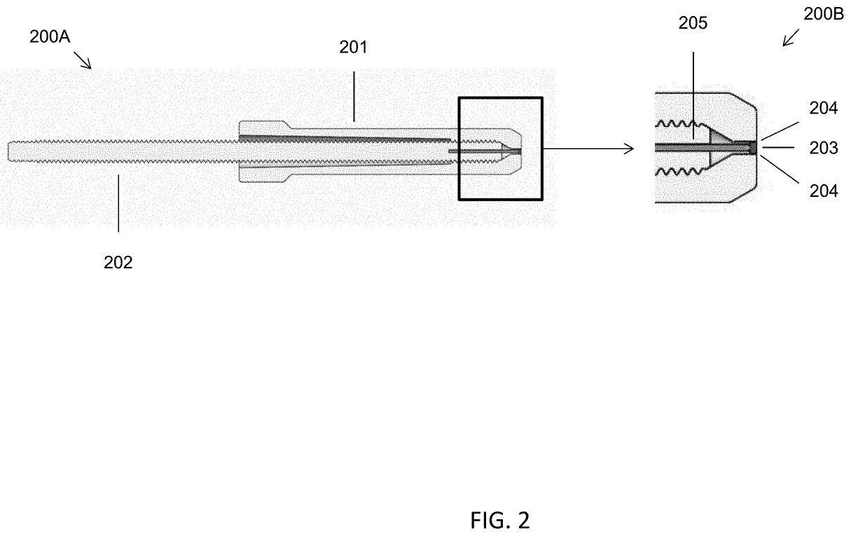

Referring now to FIG. 2, an example apparatus used for housing an electrode 200A is presented. In FIG. 2, 200B is a magnified portion of the sensor end of 200A; thus, the portions of the magnified portion 200B are present in 200A. In an embodiment, the device 200A may include a molded housing 201. The molded housing 201 may be made from a low conduction material to negate any stray conduction emitted by an electrode. For example, the molded housing may be made from silicone, a non-conductive material, or the like. In an embodiment, the molded housing 201 may be created by pouring a liquid material into a premade mold comprising the shape of the molded housing. In an embodiment, the housing may be machined from a larger piece of material. The molded housing 201 may comprise openings at each end that may vary in size. An orifice may be present at one end of the molded housing 201 that may comprise a specific shape. In an embodiment, the orifice of the molded housing may be a cone shape, where the widest part of the cone faces into the molded housing 201, while the more narrow end of a cone is exposed to the outside of the molded housing 201. The orifice of the molded housing 201 may comprise the electrode for the sensor.

The wider end of the molded housing 201 may be wide enough to accept a rod 202 made from a conductive material, which is also operatively coupled to an electrical connector 205. A rod 202 may be much larger than an electrode fitted into the orifice of the molded housing 201, thus, the opening opposite the orifice must be large enough to accept a conduction rod 202. In an embodiment, the rod 202 may be made from brass, a conductive material, or the like. In an embodiment, at the wider opening of the molded housing 201, a threading pattern may start and run through the entirety of the hollowed out molded housing 201. The molded housing 201 may comprise a threaded pattern throughout as a way to accept the rod 202 while creating a seal between the two portions of the electrochemistry sensor. In an embodiment, the seal created by screwing the rod 202 into the molded housing 201 may provide a system with the ability to fend off against outside influences, for example, aqueous solution, air born materials, contaminants, or the like. Only a certain amount of the rod 202 may be accepted in to the molded housing 201, leaving a portion of the rod 202 to stick out from the molded housing 201.

In an embodiment, an electrode 203 may be press fit into an orifice present on the molded housing 201. The smaller opening at the end of the molded housing 201 may comprise a shape rather than being an equally cylindrical hole. In an embodiment, the orifice at the end of the molded housing 201 may be designed to be a cone shape. A cone shaped orifice may be orientated in such a way that the wider portion of the cone shape is facing inward, towards the hollowed body of the molded housing 201, while the more narrow end of the cone shaped orifice may be facing outward. In an embodiment, the outward facing may refer to an environment in which the sensor receives a measurement.

In an embodiment, the electrode 203 may comprise a distinct shape as well. In an embodiment, the electrode 203 is a Boron Doped Diamond (BDD) that has a cylindrical shape with tapered sides, similar to the shape of a cone. The shape of the BDD electrode may permit the electrode to be fitted into the orifice as a near perfect match.

An electrode 203 may be press fit into the molded housing 201 using a machine press fixture until the front of the electrode is flush with the front/outside of the orifice. In an embodiment, the front of the electrode may be recessed or protrude. In an embodiment, a BDD electrode 203 may be press fitted into the molded housing 201. When the BDD electrode comprising a cylindrical shape with tapered sides is press fitted into the orifice comprising a cone shape, a seal is formed between the electrode 203 and the molded housing 201. Press fitting the electrode 203 into the orifice creates a seal because the force acting on the electrode 203 as it is being press fitted causes the molded housing 201 to stretch and completely surround the electrode 203 until the electrode is flush with the end of the molded housing 201. The press fit seal 204 causes the molded housing 201 to be flush around the entirety of the electrode 203, protecting the inner workings of the sensor 200A from outside influence.

Press fitting the electrode 203 into the molded housing 201 also supports the separation between the active electrode and the signal conduction. In an embodiment, the BDD electrode 203 is an active electrode, meaning that the electrode is continually facing reactions. The BDD electrode 203 may be active on one side and provide the signal conduction on the opposite side of the electrode. In an embodiment, the active electrode portion of the BDD electrode 203 faces outside of the molded housing 201, through the smaller portion of the orifice and is flush with the molded housing 201. While the signal conduction portion of the BDD electrode 203 faces into the molded housing, through the wider portion of the orifice. The molded housing 201 acts as a separation between the two portions of the electrode 203. Without the separation between the two portions of the electrode 203 the signal conduction may be inaccurate because of stray conduction that may be produced by the electrode 203.

In an embodiment, after the BDD electrode 203 is press fitted into the orifice within the molded housing 201, the threaded rod 202 operatively coupled to a pogo-pin 205, may be screwed into the molded housing 201 until the pogo-pin 205 makes contact with the BDD electrode 203. A pogo-pin is an electrical connector which acts as a bridge for conduction, allowing the conduction produced at the BDD electrode 203 to move to the threaded rod 202. In an embodiment, when the pogo-pin 205, operatively coupled to the brass threaded rod 202, comes in contact with the BDD electrode 203, the resistance produced by the system may drop approximately 20-40 Ohms. Additionally or alternatively, a user may determine that the pogo pin 205 has made electrical contact with the electrode 203 by measuring the resistance between the conductor 202 and the electrode 203. The pogo-pin 205 may contact only the conductor (threaded rod) 202 and the electrode 203. The pogo-pin may not touch the molded housing 201, though it is located within the molded housing 201. Also, when the pogo-pin 205 makes contact with the electrode 203 in a system, the pogo-pin 205 should be fully seated against the electrode 203 to produce an accurate value.

Up until now, producing electrochemistry sensor housing was largely time consuming and inconsistent process. An embodiment describes how a molded housing 201 containing an electrode 203 in an orifice, comprising a press fit seal 204, at one end of the molded housing 201, along with a threaded conduction rod 202 operatively coupled to an electrical contact 205, may be assembled to overcome the time restraints and inconsistent process of the conventional systems used to house electrochemistry sensors. An embodiment also provides information with a higher accuracy than conventional methods because of a system's design and ability to separate the active electrode from the signal conduction.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device, where the instructions are executed by a processor. In the context of this document, a storage device is not a signal and “non-transitory” includes all media except signal media.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and products according to various example embodiments. It will be understood that the actions and functionality may be implemented at least in part by program instructions. These program instructions may be provided to a processor of a device, e.g., a measurement device such as illustrated in FIG. 1, or other programmable data processing device to produce a machine, such that the instructions, which execute via a processor of the device, implement the functions/acts specified.

It is noted that the values provided herein are to be construed to include equivalent values as indicated by use of the term “about.” The equivalent values will be evident to those having ordinary skill in the art, but at the least include values obtained by ordinary rounding of the last significant digit.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. An electrochemistry sensor, comprising;
a sensor housing;
an electrode, wherein the electrode is located within the sensor housing and is located within an orifice at the end of the sensor housing, thereby being exposed to outside the sensor housing and held within the sensor housing; and
a rod coupled to an electrical connector, the rod being at least partially housed within the sensor housing, wherein the electrical connector contacts the electrode.

2. The electrochemistry sensor of claim 1, wherein the rod comprises a threaded rod that is threaded into threads of the sensor housing.

3. The electrochemistry sensor of claim 1, wherein the rod comprises a conductive material.

4. The electrochemistry sensor of claim 1, wherein the electrode is press fitted into the sensor housing, thereby holding the electrode within the sensor housing.

5. The electrochemistry sensor of claim 1, wherein the electrode comprises a cylindrical shape with tapered sides.

6. The electrochemistry sensor of claim 5, where in the orifice comprises a cone shaped opening substantially matching the cylindrical shape of the electrode and wherein the electrode is located within the cone shape opening.

7. The electrochemistry sensor of claim 1, wherein the electrode comprises a Boron Doped Diamond crystal.

8. The electrochemistry sensor of claim 1, wherein the electrical connector comprises a pogo-pin.

9. The electrochemistry sensor of claim 1, wherein the electrical connector directs the conduction of the electrode into the threaded rod.

10. The electrochemistry sensor of claim 1, wherein the sensor housing comprises a low conduction material to reduce stray conduction of the electrode.

11. A system for measuring chemical characteristics, comprising;
a measurement chamber;
a sensor housing located in the measurement chamber;
an electrode, wherein the electrode is located within the sensor housing and is located within an orifice at the end of the sensor housing, thereby being exposed to outside the sensor housing and held within the sensor housing; and
a rod coupled to an electrical connector, the rod being at least partially housed within the sensor housing, wherein the electrical connector contacts the electrode.

12. The system for measuring chemical characteristics of claim 1, wherein the rod comprises a threaded rod that is threaded into the threads of the sensor housing.

13. The system for measuring chemical characteristics of claim 1, wherein the rod comprises a conductive material.

14. The system for measuring chemical characteristics of claim 1, wherein the electrode is press fitted into the sensor housing, thereby holding the electrode within the sensor housing.

15. The system for measuring chemical characteristics of claim 1, wherein the electrode comprises a cylindrical shape with tapered sides.

16. The system for measuring chemical characteristics of claim 5, wherein the orifice comprises a cone shaped opening substantially matching the cylindrical shape of the electrode and wherein the electrode is located within the cone shaped opening.

17. The system for measuring chemical characteristics of claim 1, wherein the electrode comprises a Boron Doped Diamond crystal.

18. The system for measuring chemical characteristics of claim 1, wherein the electrical connector comprises a pogo pin.

19. The system for measuring chemical characteristics of claim 1, wherein the electrical connector directs the conduction of the electrode into the threaded rod.

20. An electrochemistry sensor, comprising;
a sensor housing, wherein the sensor housing comprises a low conduction material to reduce stray conduction form the electrode;
an electrode, wherein the electrode is located within the sensor housing and located within an orifice at the end of the sensor housing, thereby being exposed to outside the sensor housing and held within the sensor housing, wherein the electrode is press fitted into the sensor housing, thereby holding the electrode within the sensor housing; and
a rod coupled to an electrical connector, the rod being at least partially housed within the sensor housing, wherein the electrical connector contacts the electrode, wherein the rod comprises a threaded rod that is threaded into the threads of the sensor housing, wherein the rod comprises a conductive material, wherein the electrical connector comprises a pogo-pin.
